(19) United States
(12) Patent Application Publication
(10) Pub. No.: US 2024/0243513 A1
(43) Pub. Date: Jul. 18, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nungna WI, Mie (JP); Teruo HARA, Mie (JP); Masaaki TABATA, Mie (JP)

(21) Appl. No.: 18/289,535

(22) PCT Filed: May 10, 2022
(86) PCT No.: PCT/JP2022/019815

§ 371 Date: Nov. 3, 2023

(30) Foreign Application Priority Data
May 14, 2021 (JP) 2021-082096

(51) Int. Cl. H01R 13/52; H01R 4/48; H01R 13/506

(52) U.S. Cl. CPC H01R 13/5208; H01R 4/4826; H01R 13/506

(57) ABSTRACT

A connector of the present disclosure is provided with a wire including a core wire, a terminal connected to the core wire, an inner housing including a terminal accommodating portion accommodating the terminal inside, an outer housing including a housing accommodating portion accommodating the inner housing inside, a rear holder for holding the inner housing in a state accommodated in the housing accommodating portion by being assembled with the outer housing, and a one-piece sealing portion mounted in the rear holder. The rear holder includes a wire insertion hole, through which the wire is inserted. The one-piece sealing portion includes an inner sealing portion for sealing the wire inserted through the wire insertion hole and an outer sealing portion for sealing between the rear holder and the outer housing, and the inner sealing portion and the outer sealing portion are constituted by one member.

### TECHNICAL FIELD

The present disclosure relates to a connector.

### BACKGROUND

Conventionally, a connector described in Japanese Patent Laid-Open Publication No. 2019-145208 (Patent Document 1 below) is known as a connector for accommodating a terminal-equipped wire in which a terminal is connected to a core wire exposed from an end of a wire. This connector is provided with a terminal including a terminal body and a slide portion, a connector housing including a cavity for accommodating the terminal and a rear holder to be locked to the rear end of the terminal. With the slide portion held at a complete locking position with respect to the terminal body, an upper contact portion of the slide portion comes into contact with an upper connecting piece of the terminal body from above and presses the upper connecting piece downward and a lower contact portion of the slide portion comes into contact with a lower connecting piece of the terminal body from below and presses the lower connecting piece upward. In this way, the core wire is vertically sandwiched by the upper and lower connecting pieces and the wire and the terminal are electrically connected.

### PRIOR ART DOCUMENT

### Patent Document

Patent Document 1: JP 2019-145208 A

### SUMMARY OF THE INVENTION

### Problems to be Solved

The above connector is a non-waterproof connector. If an attempt is made to make this connector waterproof, the above connector housing is first used as an inner housing, an outer housing disposed on an outer peripheral side of the inner housing is provided, and the inner housing is surrounded and accommodated by the outer housing and the rear holder. Moreover, it is thought to mount a one-piece rubber plug into a rear end part of the inner housing, thereby making the wire inserted into a wire insertion hole waterproof, and mount a rubber ring between the rear holder and the outer housing, thereby making the inside of the rear holder and the inside of the outer housing waterproof. As just described, two parts need to be made waterproof, and the number of components increases since the one-piece rubber plug and the rubber ring are necessary.

### Means to Solve the Problem

The present disclosure is directed to a connector with a wire including a core wire, a terminal connected to the core wire, an inner housing including a terminal accommodating portion accommodating the terminal inside, an outer housing including a housing accommodating portion accommodating the inner housing inside, a rear holder for holding the inner housing in a state accommodated in the housing accommodating portion by being assembled with the outer housing, and a one-piece sealing portion mounted in the rear holder, the rear holder including a wire insertion hole, the wire being inserted through the wire insertion hole, and the one-piece sealing portion including an inner sealing portion for sealing the wire inserted through the wire insertion hole and an outer sealing portion for sealing between the rear holder and the outer housing, the inner sealing portion and the outer sealing portion being constituted by one member.

### Effect of the Invention

According to the present disclosure, since the inner sealing portion and the outer sealing portion are constituted by one member, the inner housing can be made waterproof without increasing the number of components.

### BRIEF DESCRIPTION OF THE DRAWINGS

FIG. 1 is a perspective view of a connector when viewed obliquely from front.

FIG. 2 is an exploded perspective view showing constituent components of the connector.

FIG. 3 is a front view of the connector.

FIG. 4 is a section along A-A of FIG. 3.

FIG. 5 is a section along B-B of FIG. 3.

FIG. 6 is a side view of the connector.

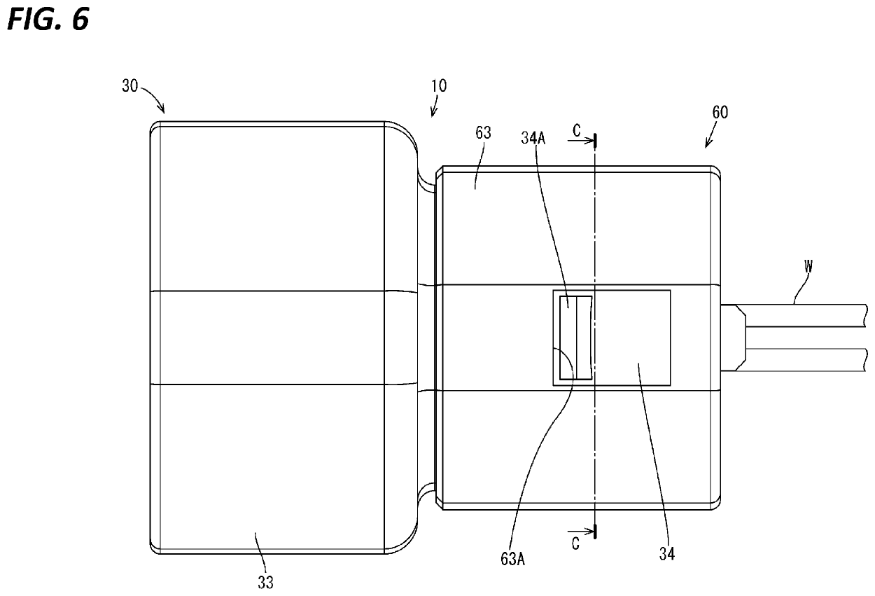

FIG. 7 is a section along C-C of FIG. 6.

FIG. 8 is a front view of a rear holder integrally formed with a one-piece sealing portion.

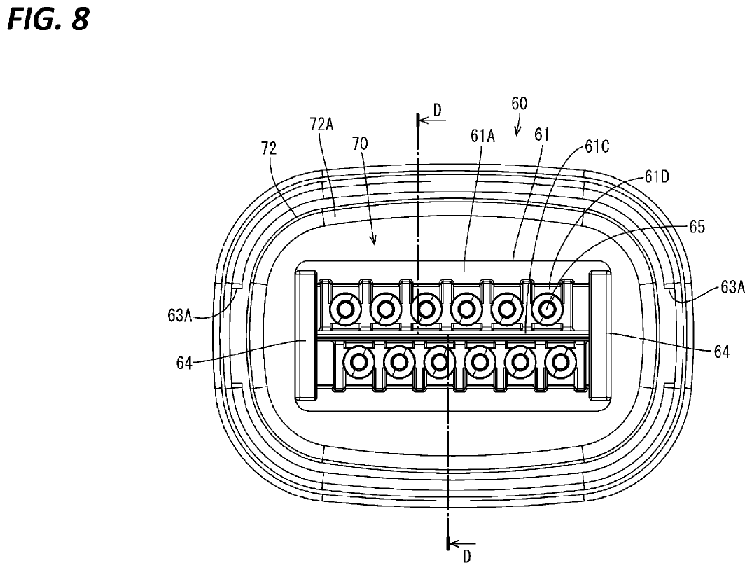

FIG. 9 is a section along D-D of FIG. 8.

FIG. 10 is a front view when only the rear holder is viewed from front.

FIG. 11 is a perspective view in section along E-E of FIG. 10 when viewed obliquely from a front-upper side.

FIG. 12 is a side view when only the rear holder is viewed sideways.

FIG. 13 is a section along F-F of FIG. 12.

### DETAILED DESCRIPTION TO EXECUTE THE INVENTION

### Description of Embodiments of Present Disclosure

First, embodiments of the present disclosure are listed and described.

(1) The connector of the present disclosure is provided with a wire including a core wire, a terminal connected to the core wire, an inner housing including a terminal accommodating portion accommodating the terminal inside, an outer housing including a housing accommodating portion accommodating the inner housing inside, a rear holder for holding the inner housing in a state accommodated in the housing accommodating portion by being assembled with the outer housing, and a one-piece sealing portion mounted in the rear holder, the rear holder including a wire insertion hole, the wire being inserted through the wire insertion hole, and the one-piece sealing portion including an inner sealing portion for sealing the wire inserted through the wire insertion hole and an outer sealing portion for sealing between the rear holder and the outer housing, the inner sealing portion and the outer sealing portion being constituted by one member.

Since the wire inserted through the wire insertion hole is sealed by the inner sealing portion of the one-piece sealing portion and sealing is provided between the rear holder and the outer housing by the outer sealing portion of the one-piece sealing portion, the inner housing can be made waterproof. At that time, since the inner sealing portion and the outer sealing portion are constituted by one member, the number of components can be reduced.

(2) Preferably, the one-piece sealing portion and the rear holder are constituted by one member.

Since the one-piece sealing portion needs not be mounted in the rear holder, the number of mounting steps can be reduced. For example, the one-piece sealing portion and the rear holder may be constituted by one member by forming the one-piece sealing portion in the rear holder by two-color molding.

(3) Preferably, the outer housing includes a seal accommodating portion for accommodating the outer sealing portion in a sealing state inside, and inside of the housing accommodating portion and that of the seal accommodating portion communicate.

Since the inside of the housing accommodating portion and that of the seal accommodating portion communicate, the housing accommodating portion and the seal accommodating portion are easily integrally molded.

(4) Preferably, the rear holder includes a holder receptacle to be externally fit to a rear part of the inner housing and a seal attaching portion disposed behind the holder receptacle, the one-piece sealing portion being attached to the seal attaching portion.

The inner housing can be made waterproof by the one-piece sealing portion attached to the seal attaching portion with the holder receptacle fit to the rear part of the inner housing.

(5) Preferably, the seal attaching portion is provided continuously behind the holder receptacle, the housing accommodating portion includes a rear housing accommodating portion for accommodating the holder receptacle, and the outer housing includes a rear receptacle composed of the rear housing accommodating portion and the seal accommodating portion.

Since the rear housing accommodating portion and the seal accommodating portion are constituted as the rear receptacle, the configuration of the outer housing can be simplified.

(6) Preferably, the rear holder includes a protection wall to be fit to an outer peripheral side of the rear receptacle, and the protection wall includes a through hole for exposing a part of the outer sealing portion to outside before the protection wall is fit to the rear receptacle.

For example, when the one-piece sealing portion is attached to the seal attaching portion by two-color molding, liquid rubber serving as a raw material of the one-piece sealing portion may be injected to the seal attaching portion using the through hole.

(7) Preferably, the rear receptacle includes a lock protrusion for holding the rear holder in a state mounted on the rear receptacle by being locked to an inner wall of the through hole.

The rear holder can be held in the state mounted on the rear receptacle by locking the lock protrusion to the inner wall of the through hole.

(8) Preferably, the outer housing includes a front receptacle open forward, and the front receptacle extends forward to a front end of the housing accommodating portion after extending radially outward from a front end of the rear receptacle.

For example, when a mating housing and the outer housing are connected, the mating housing may be fit to an inner peripheral side of the front receptacle.

### Details of Embodiment of Present Disclosure

A specific example of a connector 10 of the present disclosure is described below with reference to the drawings. Note that the present disclosure is not limited to these illustrations, but is represented by claims and intended to include all changes in the scope of claims and in the meaning and scope of equivalents.

### [Connector]

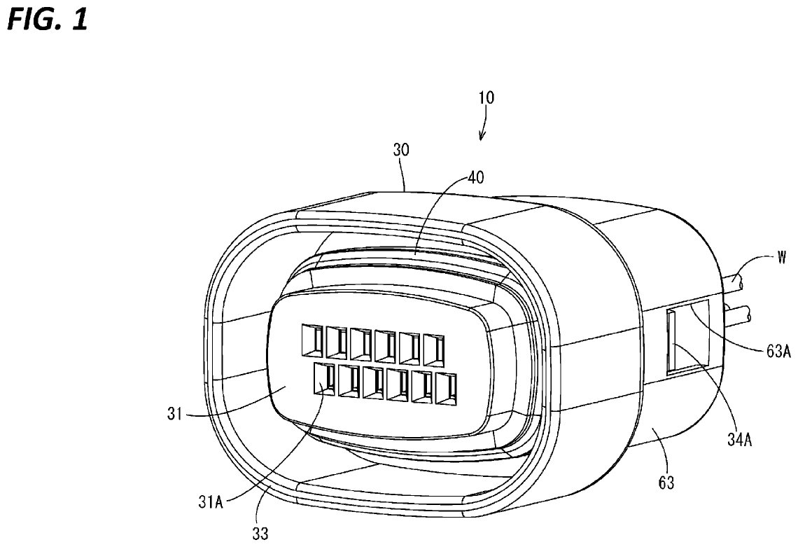

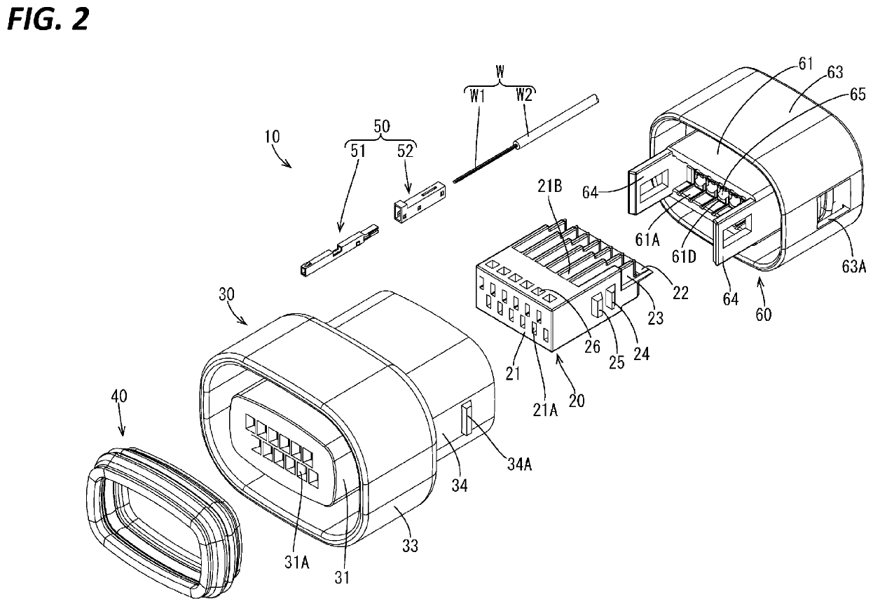

As shown in FIGS. 1 and 2, the connector 10 is provided with an inner housing 20, an outer housing 30, a sealing ring 40, terminals 50, wires W, a rear holder 60 and a one-piece sealing portion 70.

### [Wire]

The wire W is provided with a core wire W1 and an insulation coating W2 made of insulating synthetic resin and surrounding the outer peripheral surface of the core wire W1. The insulation coating W2 is stripped in an end part of the wire W to expose the core wire W1. The core wire W1 is a so-called single core wire constituted by one metal wire. Note that the core wire W1 may be a stranded wire formed by twisting a plurality of metal thin wires. An arbitrary metal such as copper, copper alloy, aluminum or aluminum alloy can be appropriately selected as a metal for constituting the core wire W1 if necessary. The core wire W1 of this embodiment is made of copper or copper alloy.

### [Terminal]

The terminal 50 is a female terminal and provided with a terminal body 51 made of metal and a slide portion 52 relatively slidable with respect to the terminal body 51. The terminal body 51 is formed into a predetermined shape by a known method such as press-working, cutting or casting. An arbitrary metal such as copper, copper alloy, aluminum, aluminum alloy or stainless steel can be appropriately selected as a metal for constituting the terminal body 51 if necessary. The terminal body 51 of this embodiment is made of copper or copper alloy. A plating layer may be formed on the surface of the terminal body 51. An arbitrary metal such as tin, nickel or silver can be appropriately selected as a metal for constituting the plating layer if necessary. Tin plating is applied to the terminal body 51 of this embodiment.

### [Terminal Body]

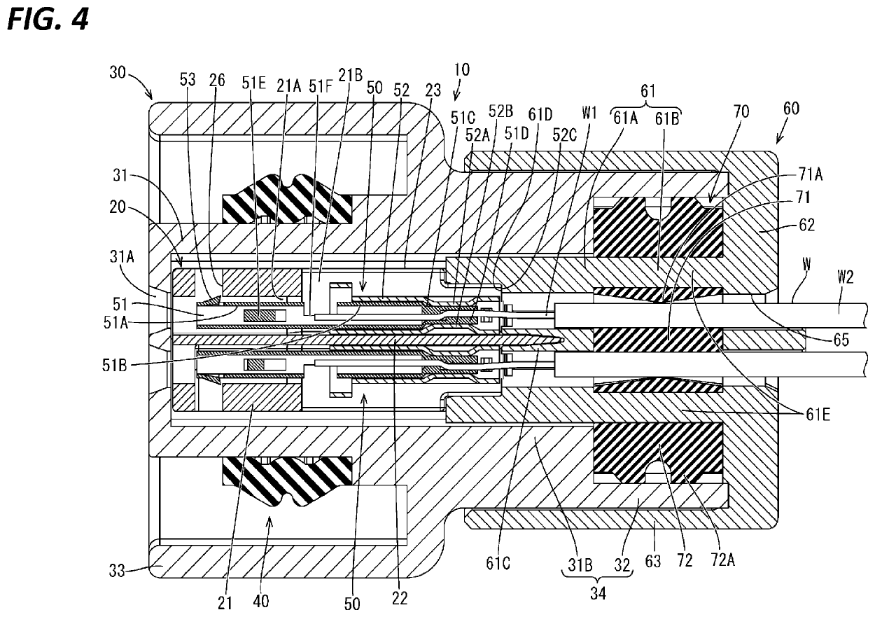

As shown in FIG. 4, the terminal body 51 includes a connecting tube portion 51A in the form of a rectangular tube, into which a mating male terminal (not shown) is inserted, a base portion 51B in the form of a rectangular tube disposed behind the connecting tube portion 51A and an upper connecting piece 51C and a lower connecting piece 51D extending rearward from the base portion 51B. The front end of the connecting tube portion 51A is open so that the mating male terminal is insertable.

A resiliently deformable resilient contact piece 51E is disposed on a side wall of the connecting tube portion 51A. The male terminal inserted into the connecting tube portion 51A contacts the resilient contact piece 51E. Further, a locking lance 53 made of metal and formed by cutting and raising a part of the connecting tube portion 51A is provided on a front end part of the upper wall of the connecting tube portion 51A.

The upper connecting piece 51C is formed to be resiliently deformable in the vertical direction with a rear end part of the upper wall of the base portion 51B as a fulcrum. The lower connecting piece 51D is formed to be resiliently deformable in the vertical direction with a rear end part of the lower wall of the base portion 51B as a fulcrum. The upper and lower connecting pieces 51C, 51D are formed to have substantially the same length in the front-rear direction.

The terminal body 51 is further provided with a terminal window portion 51F open upward at a position behind the connecting tube portion 51A and in front of the base portion 51B. A front end part of the core wire W1 can be detected through the terminal window portion 51F with the core wire W1 disposed in a space between the upper and lower connecting pieces 51C, 51D. Being detectable means being visually confirmable by a worker from outside, means being detectable by a camera (not shown) from outside and also means the electrical detection of the front end part of the core wire W1 by inserting a probe (not shown) from outside.

### [Slide Portion]

The slide portion 52 is in the form of a rectangular tube extending in the front-rear direction. The slide portion 52 is formed by a known method such as cutting, casting or press-working if necessary. An arbitrary metal such as copper, copper alloy, aluminum, aluminum alloy or stainless steel can be appropriately selected as a metal for constituting the slide portion 52 if necessary. The slide portion 52 of this embodiment is made of copper or copper alloy. A plating layer may be formed on the surface of the slide portion 52. An arbitrary metal such as tin, nickel or silver can be appropriately selected as a metal for constituting the plating layer if necessary. Tin plating is applied to the slide portion 52 of this embodiment.

The slide portion 52 is so formed to have a cross-sectional shape, which is the same as or somewhat larger than that of a region of the terminal body 51 where the upper and lower connecting pieces 51C, 51D are provided. In this way, the slide portion 52 is externally fittable to the region of the terminal body 51 where the upper and lower connecting pieces 51C, 51D are provided.

An upper contact portion 52A projecting downward is provided on the lower surface of the upper wall of the slide portion 52. A lower contact portion 52B projecting upward is provided on the upper surface of the lower wall of the slide portion 52.

The slide portion 52 is slidable between a temporary locking position (not shown) and a complete locking position (position of the slide portion 52 in FIG. 4) set forward of the temporary locking position with the slide portion 52 externally fit to the region of the terminal body 51 where the upper and lower connecting pieces 51C, 51D are provided. With the slide portion 52 held at the complete locking position with respect to the terminal body 51, the upper contact portion 52A is in contact with the upper surface of the upper connecting piece 51C from above and the lower contact portion 52B is in contact with the lower surface of the lower connecting piece 51D from below.

With the slide portion 52 held at the complete locking position with respect to the terminal body 51, the upper contact portion 52A presses the upper connecting piece 51C from above, whereby the upper connecting piece 51C is resiliently deformed downward. Further, the lower contact portion 52A presses the lower connecting piece 51D from below, whereby the lower connecting piece 51D is resiliently deformed upward. In this way, in a state where the core wire W1 is disposed to extend in the front-rear direction in the space between the upper and lower connecting pieces 51C, 51D and the slide portion 52 is held at the complete locking position with respect to the terminal body 51, the core wire W1 is sandwiched in the vertical direction by the resiliently deformed upper and lower connecting pieces 51C, 51D. That is, the upper connecting piece 51C contacts the core wire W1 pressed downward by the upper contact portion 52A from above and the lower connecting piece 51D contacts the core wire W1 pressed upward by the lower contact portion 52B from below.

A front part of the upper connecting piece 51C projects downward, a rear part of the lower connecting piece 51D projects upward, and these projecting parts are shifted in the front-rear direction. Thus, the core wire W1 is held in a state bent in the vertical direction. In this way, the core wire W1 and the terminal 50 are electrically connected, and the terminal 50 is firmly held retained against rearward pulling of the wire W.

### [Inner Housing]

As shown in FIG. 2, the inner housing 20 is made of insulating synthetic resin and includes a terminal accommodating portion 21 for accommodating the plurality of terminals 50. The inner housing 20 has a substantially rectangular parallelepiped shape flat in the vertical direction and extending in the lateral direction. The terminal accommodating portion 21 includes a plurality of cavities 21A penetrating therethrough in the front-rear direction. The plurality of cavities 21A are arranged in parallel at intervals in the lateral direction and in two upper and lower stages. The cavities 21A formed in the upper stage and those formed in the lower stage are disposed at positions shifted in the lateral direction when viewed from above. Note that the number of the cavities 21A is arbitrary and the number of vertical stages is also arbitrary.

The unillustrated male terminal is insertable into the cavity 21A from front. As shown in FIG. 4, the terminal 50 is inserted into the cavity 21A from behind, and the terminal 50 can be accommodated inside the terminal accommodating portion 21.

With the terminal 50 accommodated in the cavity 21A, a connector window portion 21B is formed at a position of the terminal accommodating portion 21 corresponding to the terminal window portion 51F of the terminal 50. The terminal window portion 51F communicates with outside through this connector window portion 21B. The terminal window portion 51F of the terminal 50 is detectable through the connector window portion 21B. In this way, the front end part of the core wire W1 is detectable from outside through the connector window portion 21B and the terminal window portion 51F.

As shown in FIG. 2, the inner housing 20 includes a separation wall 22 partitioning between the cavities 21A in the upper stage and those in the lower stage. The separation wall 22 extends rearward from rear end parts of the cavities 21A. Partition walls 23 extending in the front-rear direction and projecting upward or downward are provided on each of the upper and lower surfaces of the separation wall 22. The terminals 50 accommodated in the respective cavities 21A are electrically insulated from the terminals 50 adjacent in the lateral direction by these partition walls 23.

Temporary locking portions 24 projecting outward are provided at positions near rear end parts of both left and right side walls of the inner housing 20, and complete locking portions 25 are provided at positions forward of the temporary locking portions 24.

As shown in FIG. 4, a lance hole 26 is provided to be open upward on a front end side of the cavity 21A in the upper stage, and a lance hole 26 is provided to be open downward on a front end side of the cavity 21A in the lower stage. The locking lance 53 of the terminal 50 is locked to an inner wall constituting the lance hole 26, whereby the terminal 50 is held accommodated in the cavity 21A.

### [Rear Holder]

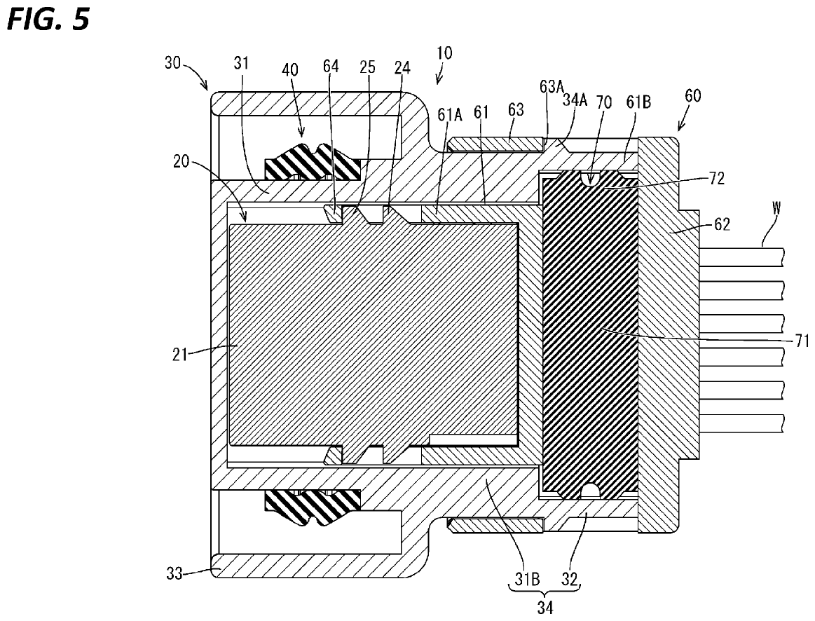

As shown in FIGS. 4 and 5, the rear holder 60 is made of insulating synthetic resin and provided with a holder base portion 62, a holder body 61 projecting forward from the holder base portion 62 and a tubular protection wall 63 disposed on an outer peripheral side of the holder body 61 and projecting forward from the holder base portion 62. The rear holder 60 is formed by injection-molding an insulating synthetic resin.

The holder body 61 includes a box-shaped holder receptacle 61A open forward and a seal attaching portion 61B continuously provided behind the holder receptacle 61. The holder receptacle 61A is externally fit to a rear part of the inner housing 20. As shown in FIG. 2, substantially gate-shaped lock receiving portions 64 are provided on front end parts of both left and right side walls of the holder receptacle 61A. As shown in FIG. 5, the lock receiving portions 64 are resiliently lockable to the temporary locking portions 24 and the complete locking portions 25 of the inner housing 20.

By locking the temporary locking portions 24 of the inner housing 20 and the lock receiving portions 64 of the holder body 61, the rear holder 60 is held at a temporary locking position (not shown) with respect to the inner housing 20. Further, by locking the complete locking portions 25 of the inner housing 20 and the lock receiving portions 64 of the holder body 61, the rear holder 60 is held at a complete locking position (position of the rear holder 60 shown in FIG. 5) with respect to the inner housing 20.

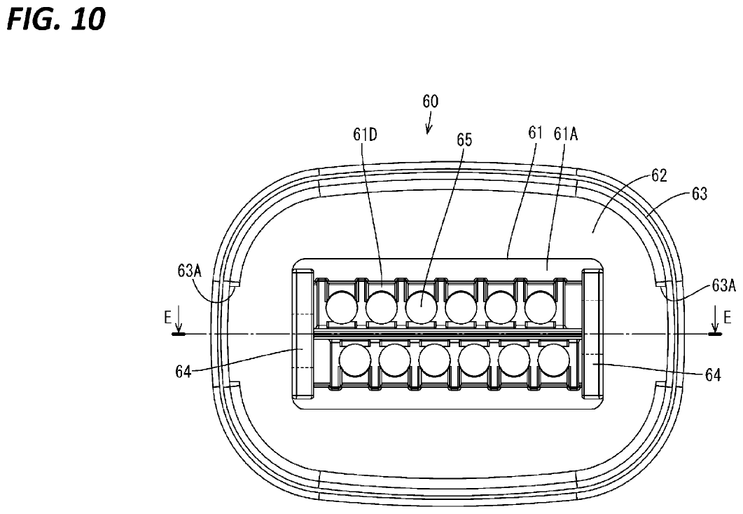

As shown in FIG. 10, the rear holder 60 includes a plurality of wire insertion holes 65, through which the wires W are inserted. The plurality of wire insertion holes 65 are arranged in parallel in the lateral direction and in two upper and lower stages. Each wire insertion hole 65 is provided at a position corresponding to each cavity 21A of the inner housing 20. An inner diameter of the wire insertion hole 65 is set to be equal to or somewhat larger than an outer diameter of the insulation coating W2 of the wire W.

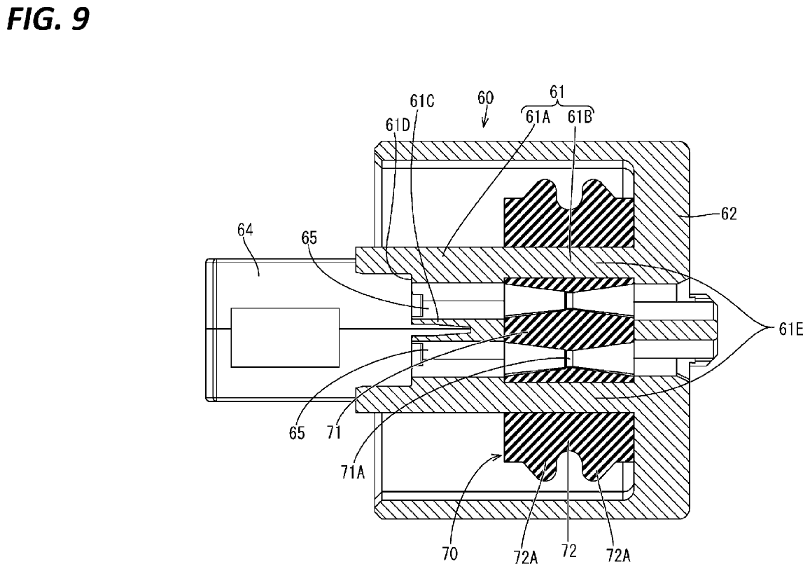

As shown in FIG. 9, a separation wall receiving portion 61C is provided near a vertical center of the back wall of the holder receptacle 61A. This separation wall receiving portion 61C is open forward, and a vertical diameter of an opening is set to be equal to or somewhat larger than a vertical thickness of the separation wall 22 of the inner housing 20.

Although not shown, with the rear holder 60 held at the temporary locking position with respect to the inner housing 20, the separation wall receiving portion 61C of the holder body 61 is located behind the rear end edge of the separation wall 22 of the inner housing 20. As shown in FIG. 4, with the rear holder 60 held at the complete locking position with respect to the inner housing 20, the separation wall 22 of the inner housing 20 is fit in the opening of the separation wall receiving portion 61C of the holder body 61. In this way, a position shift of the rear holder 60 in the vertical direction with respect to the inner housing 20 is suppressed.

As shown in FIG. 9, steps 61D are formed at the front end positions of the wire insertion holes 65 on the inner wall of the holder receptacle 61A. These steps 61D come into contact with rear end parts 52C of the slide portions 52 when the rear holder 60 moves from the temporary locking position to the complete locking position with respect to the inner housing 20. In this way, the terminals 50 are held while being prevented from coming out rearward with the terminals 50 accommodated in the cavities 21A of the inner housing 20.

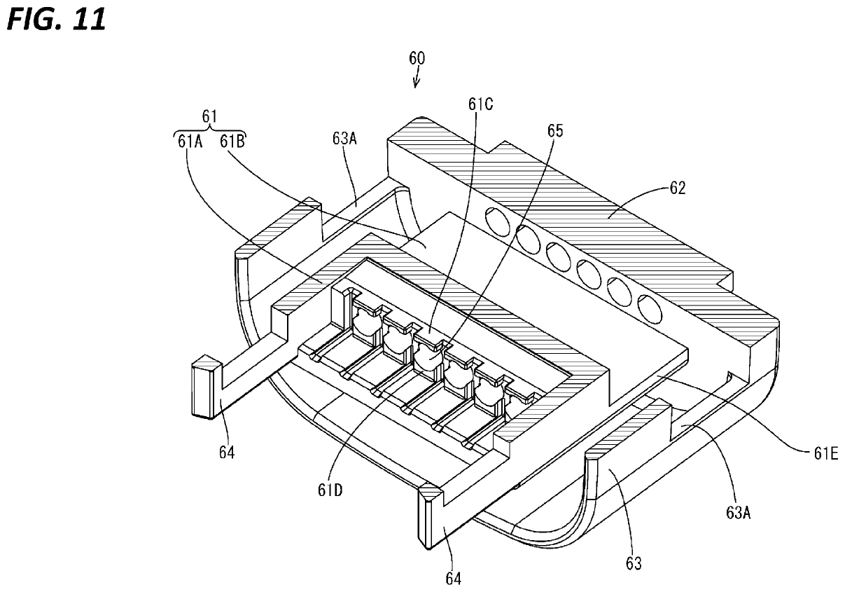

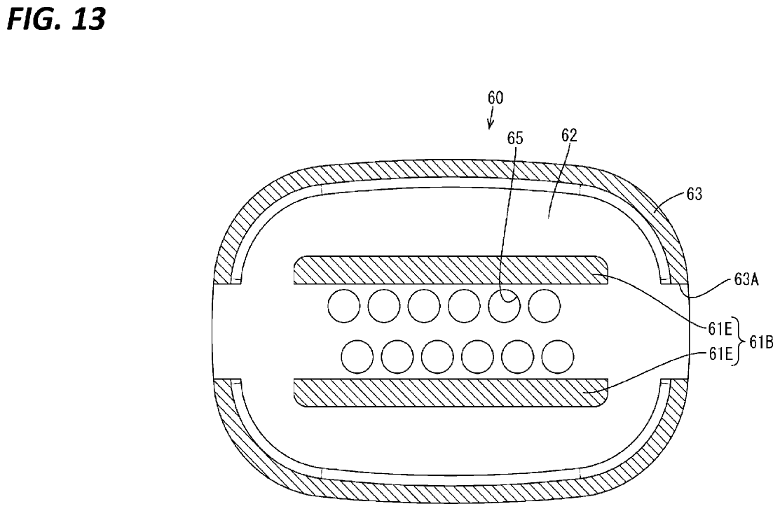

As shown in FIGS. 11 and 13, the seal attaching portion 61B is composed of a pair of upper and lower attachment walls 61E. The front end of the upper attachment wall 61E is coupled to the rear end of the upper wall of the holder receptacle 61A, and the rear end of the upper attachment wall 61E is coupled to the holder base portion 62. The front end of the lower attachment wall 61E is coupled to the rear end of the lower wall of the holder receptacle 61A, and the rear end of the lower attachment wall 61E is coupled to the holder base portion 62. The one-piece sealing portion 70 is integrally attached to the seal attaching portion 61B by two-color molding.

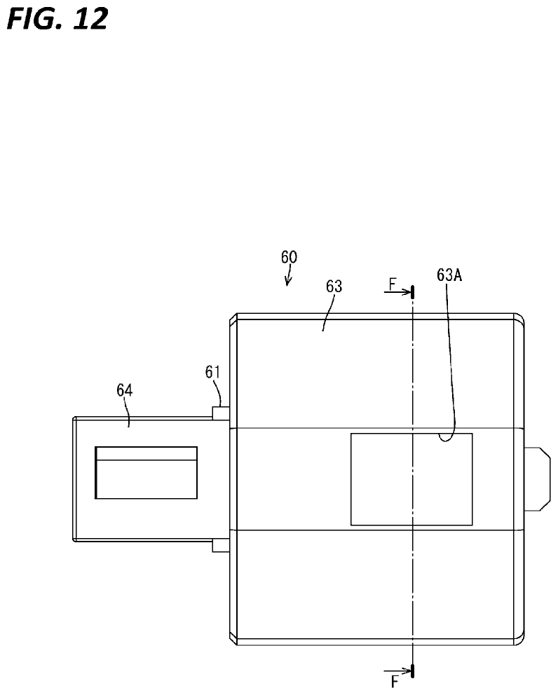

As shown in FIGS. 10 and 11, the protection wall 63 has a tubular shape open forward. The protection wall 63 has an elliptical shape long in the lateral direction when viewed from front. The holder body 61 is accommodated into the inside of the protection wall 63. A pair of through holes 63A are provided in both left and right side walls of the protection wall 63. As shown in FIG. 12, the through hole 63A has a rectangular shape long in the front-rear direction when viewed laterally.

As show in FIGS. 12 and 13, a space between the pair of upper and lower attachment walls 61E is aligned with the through holes 63A when the rear holder 60 is viewed laterally. Therefore, the lower surface of the upper attachment wall 61E and the upper edges of the through holes 63A are disposed at the same height, and the upper surface of the lower attachment wall 61E and the lower edges of the through holes 63A are disposed at the same height.

### [One-Piece Sealing Portion]

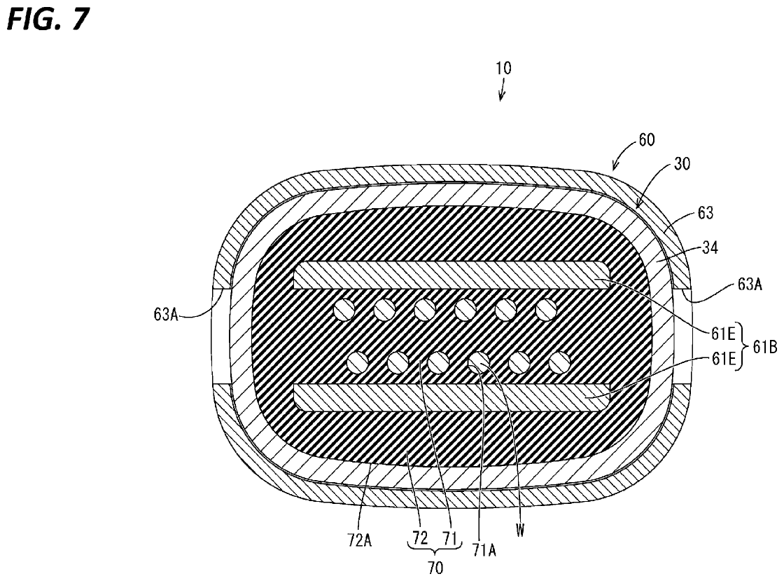

The one-piece sealing portion 70 is made of rubber and includes, as shown in FIG. 7, an inner sealing portion 71 disposed between the pair of attachment walls 61E and an outer sealing portion 72 disposed on an outer peripheral side of the inner sealing portion 71.

The inner sealing portion 71 seals the wires W inserted through the wire insertion holes 65. As shown in FIG. 9, the inner sealing portion 71 includes inner peripheral lips 71A having a smallest inner diameter near a center in the front-rear direction. An inner diameter of the inner peripheral lip 71A is smaller than an outer diameter of the wire W. The outer sealing portion 71 includes outer peripheral lips 72A formed on the outer peripheral surface of the outer sealing portion 72. The outer peripheral lips 72A are provided over the entire periphery of the outer sealing portion 72. The outer peripheral lips 72A are covered by the protection wall 63. The outer sealing portion 72 seals between the outer housing 30 and the rear holder 60.

### [Outer Housing]

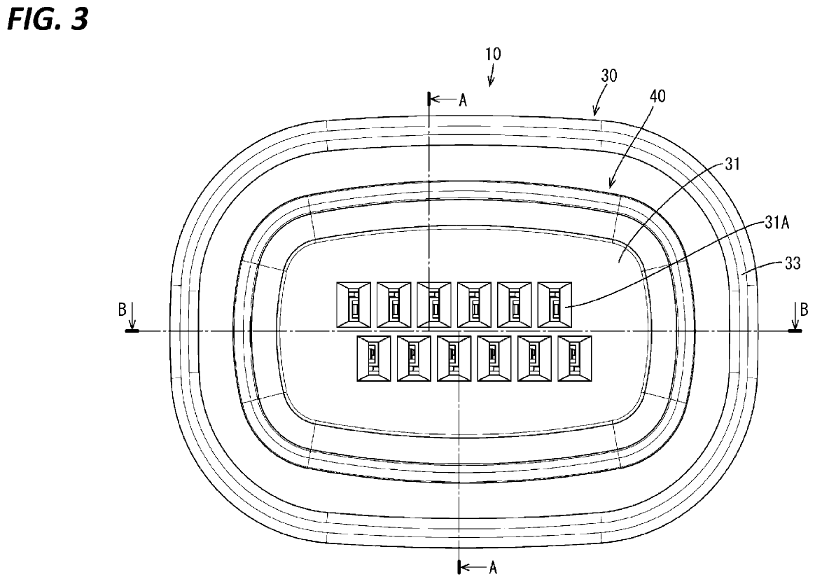

The outer housing 30 is made of insulating synthetic resin and, as shown in FIGS. 4, provided with a housing accommodating portion 31, a seal accommodating portion 32, a front receptacle 33 disposed on an outer peripheral side of the housing accommodating portion 31 and open forward, and a rear receptacle 34 disposed behind the front receptacle 33 and open rearward. As shown in FIG. 3, a plurality of terminal entrance holes 31A disposed to correspond to the positions of the plurality of cavities 21A of the inner housing 20 are provided in the front wall of the housing accommodating portion 31. The terminal entrance hole 31A is a hole, into which the male terminal (not shown) to be connected to the terminal 50 is inserted from front.

The inside of the housing accommodating portion 31 and that of the seal accommodating portion 32 communicate. A dimension in the front-rear direction of the housing accommodating portion 31 is larger than that of the seal accommodating portion 32 and about three times as large as that of the seal accommodating portion 32. A vertical dimension of the seal accommodating portion 32 is larger than that of the housing accommodating portion 31 as shown in FIG. 4, and a lateral dimension of the seal accommodating portion 32 is larger than that of the housing accommodating portion 31 as shown in FIG. 5.

The outer sealing portion 72 of the one-piece sealing portion 70 is accommodated in a sealing state inside the seal accommodating portion 32. The housing accommodating portion 31 includes a rear housing accommodating portion 31B for accommodating the holder receptacle 61A. The rear receptacle 34 is composed of the rear housing accommodating portion 31B and the seal accommodating portion 32.

As shown in FIG. 5, the rear receptacle 34 includes lock protrusions 34A for holding the protection wall 63 of the rear holder 60 in a state mounted along the outer peripheral surface of the rear receptacle 34 (state where the rear receptacle 34 is fit in the protection wall 63) by being locked to the inner walls of the through holes 63A. The lock protrusions 34 are located near the front end of the seal accommodating portion 32. With the rear receptacle 34 fit in the protection wall 63, the outer peripheral lips 72A of the outer sealing portion 72 are held in close contact with the protection wall 63, thereby sealing between the outer housing 30 and the rear holder 60.

The front receptacle 33 extends forward to the front end of the housing accommodating portion 31 after extending radially outward from the front end of the rear receptacle 34. The sealing ring 40 is mounted on the outer peripheral surface of the housing accommodating portion 31. A mating receptacle (not shown) of a mating housing is insertable into between the outer peripheral surface of the housing accommodating portion 31 and the inner peripheral surface of the front receptacle 33, and sealing is provided between the mating housing and the outer housing 30 by sandwiching the sealing ring 40 between the inner peripheral surface of the mating receptacle and the outer peripheral surface of the housing accommodating portion 31.

### [Assembling Process of Connector]

Next, an example of an assembling process of the connector 10 of this embodiment is described. The assembling process of the connector 10 is not limited to the one described below.

By a known method, the terminal bodies 51 and the slide portions 52 are formed. The slide portion 52 is assembled with the terminal body 51 from behind and the slide portion 52 is held at the temporary locking position. In this way, the terminal 50 is obtained.

By injection-molding the synthetic resin, the inner housing 20, the outer housing 30 and the rear holder 60 are formed. The terminals 50 are inserted into the cavities 21A of the inner housing 20 from behind. Liquid rubber serving as a raw material of the one-piece sealing portion 70 is injected into the rear holder 60, thereby integrally forming the rear holder 60 and the one-piece sealing portion 70 by two-color molding. In this way, the inner sealing portion 71 and the outer sealing portion 72 are constituted by one member. This leads to a reduction in the number of components and a reduction in the number of operation steps since a mounting step of the one-piece sealing portion 70 is eliminated.

The rear holder 60 is assembled with the rear end part of the inner housing 20 from behind. Then, front end parts of the lock receiving portions 64 of the rear holder 60 come into contact with the temporary locking portions 24 of the inner housing 20 from behind, and the lock receiving portions 64 are expanded and deformed. If the rear holder 60 is pushed further forward, the lock receiving portions 64 are restored and the lock receiving portions 64 are resiliently locked to the temporary locking portions 24 of the inner housing 20. In this way, the rear holder 60 is held at the temporary locking position with respect to the inner housing 20. In this state, the holder receptacle 61A of the rear holder 60 is disposed at a position separated rearward from the rear end of the inner housing 20.

The wire W is inserted through the wire insertion hole 65 of the rear holder 60 from behind, and the insulation coating W2 is stripped in an end part of the wire W, whereby the core wire W1 of a predetermined length is exposed.

If the wire W is pushed further forward, the front end part of the core wire W1 is introduced into the slide portion 52 through a rear end part of the slide portion 52. If the wire W is pushed further forward, the front end part of the core wire W1 enters the terminal body 51 and reaches the space between the upper and lower connecting pieces 51C, 51D.

By detecting the front end part of the core wire W1 in the terminal window portion 51F visible through the connector window portion 21B visually or by a probe or the like, it can be confirmed that the core wire W1 has reached a predetermined position. In a state where the slide portion 52 is held at the temporary locking position with respect to the terminal body 51 and the rear holder 60 is held at the temporary locking position with respect to the inner housing 20, the interval between the upper and lower connecting pieces 51C, 51D is set to be larger than the outer diameter of the core wire W1. Thus, when the core wire W1 is inserted into the inner housing 20, the core wire W1 does not receive a large friction force from the upper and lower connecting pieces 51C, 51D. Thus, an insertion force in inserting the wire W into the inner housing 20 can be reduced.

Subsequently, if the slide portion 52 is slid forward using a jig (not shown), the slide portion 52 is held at the complete locking position with respect to the terminal body 51. With the slide portion 52 held at the complete locking position with respect to the terminal body 51, the upper contact portion 52A of the slide portion 52 comes into contact with the upper connecting piece 51C of the terminal body 51 from above and presses the upper connecting piece 51C downward. Further, the lower contact portion 52B of the slide portion 52 comes into contact with the lower connecting piece 51D of the terminal body 51 from below and presses the lower connecting piece 51D upward. In this way, the core wire W1 is vertically sandwiched by the upper and lower connecting pieces 51C, 51D.

Subsequently, the rear holder 60 is pushed further forward with respect to the inner housing 20. Then, the front end parts of the lock receiving portions 64 of the rear holder 60 ride on the complete locking portions 25 to be expanded and deformed. If the rear holder 60 is pushed further forward, the lock receiving portions 64 of the rear holder 60 are restored and resiliently locked to the complete locking portions 25 of the inner housing 20. In this way, the rear holder 60 is held at the complete locking position with respect to the inner housing 20. In this state, the holder receptacle 61A of the rear holder 60 is externally fit to the rear part of the inner housing 20 and the inner housing 20 and the rear holder 60 are integrally configured.

Subsequently, the rear holder 60 is mounted on the outer housing 30 from behind, whereby the inner housing 20 is accommodated into the housing accommodating portion 31. The protection wall 63 of the rear holder 60 is expanded and deformed and rides on the lock protrusions 34A of the outer housing 30. If the rear holder 60 is pushed further forward, the protection wall 63 is restored and the lock protrusions 34 are resiliently locked to the inner walls of the through holes 63A. In this way, the rear holder 60 is held in a state mounted on the outer housing 30. In this state, the outer sealing portion 72 of the one-piece sealing portion 70 is accommodated inside the seal accommodating portion 32 and the outer peripheral lips 72A are held in close contact with the inner peripheral surface of the seal accommodating portion 32. Further, the steps 61D of the holder receptacle 61A are locked to the rear end parts 52C of the slide portions 52 from behind, whereby the terminals 50 are held while being prevented from coming out rearward. Further, the inner housing 20 is made waterproof by the one-piece sealing portion 70.

### Functions and Effects of Embodiment of Present Disclosure

The connector 10 of the present disclosure is provided with the wires W including the core wires W1, the terminals 50 connected to the core wires W1, the inner housing 20 including the terminal accommodating portion 21 accommodating the terminals 50 inside, the outer housing 30 including the housing accommodating portion 31 accommodating the inner housing 20 inside, the rear holder 60 for holding the inner housing 20 in the state accommodated in the housing accommodating portion 31 by being assembled with the outer housing 30, and the one-piece sealing portion 70 mounted in the rear holder 60. The rear holder 60 includes the wire insertion holes 65, through which the wires W are inserted. The one-piece sealing portion 70 includes the inner sealing portion 71 for sealing the wires W inserted through the wire insertion holes 65 and the outer sealing portion 72 for sealing between the rear holder 60 and the outer housing 30. The inner sealing portion 71 and the outer sealing portion 72 are constituted by one member.

Since the wires W inserted through the wire insertion holes 65 are sealed by the inner sealing portion 71 of the one-piece sealing portion 70 and sealing is provided between the rear holder 60 and the outer housing 30 by the outer sealing portion 72 of the one-piece sealing portion 70, the inner housing 20 can be made waterproof. At that time, since the inner sealing portion 71 and the outer sealing portion 72 are constituted by one member, the number of components can be reduced.

Preferably, the one-piece sealing portion 70 and the rear holder 60 are constituted by one member.

Since the one-piece sealing portion 70 needs not be mounted into the rear holder 60, the number of mounting steps can be reduced. For example, the one-piece sealing portion 70 and the rear holder 60 may be constituted into one member by two-color molding.

Preferably, the outer housing 30 includes the seal accommodating portion 32 for accommodating the outer sealing portion 72 in the sealing state inside, and the inside of the housing accommodating portion 31 and that of the seal accommodating portion 32 communicate.

Since the inside of the housing accommodating portion 31 and that of the seal accommodating portion 32 communicate, the housing accommodating portion 31 and the seal accommodating portion 32 are easily integrally molded.

Preferably, the rear holder 60 includes the holder receptacle 61A to be externally fit to the rear part of the inner housing 20 and the seal attaching portion 61B disposed behind the holder receptacle 61A and having the one-piece sealing portion 70 attached thereto.

With the holder receptacle 61A fit to the rear part of the inner housing 20, the inner housing 20 can be made waterproof by the one-piece sealing portion 70 attached to the seal attaching portion 61B.

Preferably, the seal attaching portion 61B is provided continuously behind the holder receptacle 61A, the housing accommodating portion 31 includes the rear housing accommodating portion 31B for accommodating the holder receptacle 61A, and the outer housing 30 includes the rear receptacle 34 constituted by the rear housing accommodating portion 31B and the seal accommodating portion 32.

Since the rear housing accommodating portion 31B and the seal accommodating portion 32 are constituted as the rear receptacle 34, the configuration of the outer housing 30 can be simplified.

Preferably, the rear holder 60 includes the protection wall 63 to be fit to the outer peripheral side of the rear receptacle 34, and the protection wall 63 includes the through holes 63A for exposing parts of the outer sealing portion 72 to outside before the protection wall 63 is fit to the rear receptacle 34.

For example, when the one-piece sealing portion 70 is formed on the seal attaching portion 61B by two-color molding, the liquid rubber serving as the raw material of the one-piece sealing portion 70 may be injected to the seal attaching portion 61B using the through holes 63A.

Preferably, the rear receptacle 34 includes the lock protrusions 34A for holding the rear holder 60 in the state mounted on the rear receptacle 34 by being locked to the inner walls of the through holes 63A.

By locking the lock protrusions 34A to the inner walls of the through holes 63A, the rear holder 60 can be held in the state mounted on the rear receptacle 34.

Preferably, the outer housing 30 includes the front receptacle 33 open forward, and the front receptacle 33 extends forward to the front end of the housing accommodating portion 31 after extending radially outward from the front end of the rear receptacle 34.

For example, when the mating housing and the outer housing 30 are connected, the mating housing may be fit to an inner peripheral side of the front receptacle 33.

### Other Embodiments

(1) Although the one-piece sealing portion 70 and the rear holder 60 are constituted by one member in the above embodiment, the one-piece sealing portion 70 and the rear holder 60 may be separately formed and the one-piece sealing portion 70 may be assembled with the rear holder 60.

(2) Although the inside of the housing accommodating portion 31 and that of the seal accommodating portion 32 communicate via the inside of the rear housing accommodating portion 31B in the above embodiment, the inside of the housing accommodating portion 31 and that of the seal accommodating portion 32 may directly communicate.

(3) Although the rear holder 60 includes the holder receptacle 61A in the above embodiment, a rear holder may include no holder receptacle. In that case, rearward movements of the terminals 50 may be suppressed by the front end of the seal attaching portion 61B.

(4) Although the seal attaching portion 61B is composed of the pair of upper and lower attachment walls 61E in the above embodiment, a pair of attachment walls may be provided on left and right sides.

(5) Although the rear receptacle 34 is composed of the rear housing accommodating portion 31B and the seal accommodating portion 32 in the above embodiment, a rear receptacle may be composed only of a seal accommodating portion.

(6) Although the protection wall 63 is externally fit to both the rear housing accommodating portion 31B and the seal accommodating portion 32 in the above embodiment, a protection wall needs only to be provided at least on the outer peripheral side of the one-piece sealing portion 70 and may be externally fit to only the seal accommodating portion 32.

(7) Although the pair of left and right through holes 63A are provided in both side surfaces of the protection wall 63 in the above embodiment, a pair of upper and lower through holes may be provided in both upper and lower surfaces of a protection wall.

(8) Although the lock protrusions 34A are provided on the surface of the rear receptacle 34 in the above embodiment, lock protrusions may be provided on tip parts of releasable lock arms and the lock protrusions may be fit into the through holes 63A from outside.

(9) Although the outer housing 30 includes the front receptacle 33 in the above embodiment, a front receptacle may be configured by causing the front end of the protection wall 63 of the rear holder 60 to extend to the front end of the housing accommodating portion 31.

### LIST OF REFERENCE NUMERALS

10: connector
20: inner housing, 21: terminal accommodating portion, 21A: cavity, 21B: connector window portion, 22: separation wall, 23: partition wall, 24: temporary locking portion, 25: complete locking portion, 26: lance hole
30: outer housing, 31: housing accommodating portion, 31A: terminal entrance hole, 31B: rear housing accommodating portion, 32: seal accommodating portion, 33: front receptacle, 34: rear receptacle, 34A: lock protrusion
40: sealing ring
50: terminal, 51: terminal body, 51A: connecting tube portion, 51B: base portion, 51C: upper connecting piece, 51D: lower connecting piece, 51E: resilient contact piece, 51F: terminal window portion, 52: slide portion, 52A: upper contact portion, 52B: lower contact portion, 52C: rear end part, 53: locking lance
60: rear holder, 61: holder body, 61A: holder receptacle, 61B: seal attaching portion, 61C: separation wall receiving portion, 61D: step, 61E: attachment wall, 62: holder base portion, 63: protection wall, 63A: through hole, 64: lock receiving portion, 65: wire insertion hole
70: one-piece sealing portion, 71: inner sealing portion, 71A: inner peripheral lip, 72: outer sealing portion, 72A: outer peripheral lip
W: wire, W1: core wire, W2: insulation coating

1. A connector, comprising:
a wire including a core wire;
a terminal connected to the core wire;
an inner housing including a terminal accommodating portion accommodating the terminal inside;
an outer housing including a housing accommodating portion accommodating the inner housing inside;
a rear holder for holding the inner housing in a state accommodated in the housing accommodating portion by being assembled with the outer housing; and
a one-piece sealing portion mounted in the rear holder,
the rear holder including a wire insertion hole, the wire being inserted through the wire insertion hole,
the one-piece sealing portion including an inner sealing portion for sealing the wire inserted through the wire insertion hole and an outer sealing portion for sealing between the rear holder and the outer housing, the inner sealing portion and the outer sealing portion being constituted by one member,
the rear holder including a pair of attachment walls, the one-piece sealing portion being attached to the pair of attachment walls, and a through hole for exposing a part of the outer sealing portion to outside before the rear holder is assembled with the outer housing, and
a space between the pair of attachment walls being aligned with the through hole when the rear holder is viewed laterally.

2. The connector of claim 1, wherein the one-piece sealing portion and the rear holder are constituted by one member.

3. The connector of claim 1, wherein the outer housing includes a seal accommodating portion for accommodating the outer sealing portion in a sealing state inside, and inside of the housing accommodating portion and that of the seal accommodating portion communicate.

4. The connector of claim 3, wherein the rear holder includes a holder receptacle to be externally fit to a rear part of the inner housing and a seal attaching portion disposed behind the holder receptacle, the one-piece sealing portion being attached to the seal attaching portion, and the seal attaching portion is constituted by the pair of attachment walls.

5. The connector of claim 4, wherein:
the seal attaching portion is provided continuously behind the holder receptacle,
the housing accommodating portion includes a rear housing accommodating portion for accommodating the holder receptacle, and
the outer housing includes a rear receptacle composed of the rear housing accommodating portion and the seal accommodating portion.

6. The connector of claim 5, wherein:
the rear holder includes a protection wall to be fit to an outer peripheral side of the rear receptacle, and
the protection wall includes the through hole for exposing the part of the outer sealing portion to outside before the protection wall is fit to the rear receptacle.

7. The connector of claim 6, wherein the rear receptacle includes a lock protrusion for holding the rear holder in a state mounted on the rear receptacle by being locked to an inner wall of the through hole.

8. The connector of claim 5, wherein:
the outer housing includes a front receptacle open forward, and
the front receptacle extends forward to a front end of the housing accommodating portion after extending radially outward from a front end of the rear receptacle.
